(19) United States
(12) Patent Application Publication
(10) Pub. No.: US 2008/0037051 A1
(43) Pub. Date: Feb. 14, 2008

(54) Document display processor, computer readable medium storing document display processing program, computer data signal and document display processing method

(75) Inventor: Takanobu Otsubo, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 11/635,055

(22) Filed: Dec. 7, 2006

(30) Foreign Application Priority Data
Aug. 10, 2006 (JP) 2006-217690

(51) Int. Cl. G06K 15/00

(52) U.S. Cl. 358/1.14

(57) ABSTRACT

A document display processor, comprising an image display that displays an image of electronic data and selectively displays apart of the image as an initial condition of the display, and a display controller that selects which part of the image is to be displayed as the initial condition by the image display, the selection is performed per electronic data or per folder storing the electronic data.

### BACKGROUND

1. Technical Field

The present invention relates to a document display processor, a computer readable medium storing a document display processing program, a computer data signal, and document display processing method for displaying electronic data of a document including a sentence, an image and the combination of these.

2. Related Art

Generally, when electronic data of a document having a concept of a page (a sheet) is visualized and is displayed on a screen of a display, an initial condition of the display (a display condition in activation) may be uniquely specified according to a type of an application program, a viewer for the display or setting by a user, for instance. For example, according to a certain application program, an uppermost part of a page may be displayed in an initial condition while display magnification is adjusted in accordance with the width of the screen; however, according to another application program, a left upper part of a page is displayed in an initial condition without compressing or decompressing data

A format of a document is often defined beforehand according to an international standard, a domestic standard, a company standard or a predetermined rule. Documents having different formats are often different in a location (a part) in which important information is described.

### SUMMARY

According to an aspect of the invention, a document display processor includes an image display that displays an image of electronic data and selectively displays a part of the image as an initial condition of the display, and a display controller that selects which part of the image is to be displayed as the initial condition by the image display, the selection is performed per electronic data or per folder storing the electronic data.

### BRIEF DESCRIPTION OF THE DRAWINGS

Exemplary embodiments of the present invention will be described in detail based on the following figures, wherein:

FIG. 1 is a block diagram showing an example of first schematic configuration of a document display processor according to the invention;

FIG. 2 is an explanatory drawing showing one concrete example of a dialog box for setting display position set information;

FIG. 3 is a block diagram showing an example of second schematic configuration of the document display processor according to the invention;

FIG. 4 is a block diagram showing an example of third schematic configuration of the document display processor according to the invention; and

FIG. 5 is an explanatory drawing showing one concrete example of a dialog box for changing the setting of display position set information.

### DETAILED DESCRIPTION

A document display processor and a computer readable medium storing a document display processing program respectively according to the invention will be described referring to the drawings below.

The document display processor and the computer readable medium storing the document display processing program respectively described in these exemplary embodiments visualize and display electronic data to enable editing the electronic data of a document including a sentence, an image and the combination of these (hereinafter merely called electronic data) and applying processing such as working to the electronic data. Electronic data to be displayed is that of a document having a concept of a page (a sheet) and is equivalent to that of a document including plural pages and that of a document (for example, a drawing) the form size of which is defined though the document includes a single page. Although a data format is not particularly limited, a tree structure in units of page, that is, a hierarchical structure that one or plural pages exist under one data file name can be given for one example.

### First Embodiment

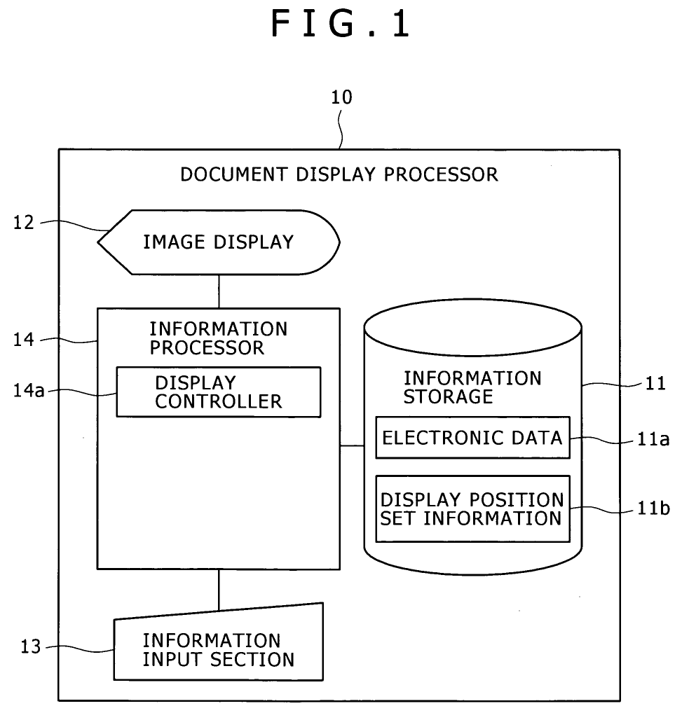

First, a first exemplary embodiment of the invention will be described. FIG. 1 is a block diagram showing an example of first schematic configuration of a document display processor according to the invention.

As shown in FIG. 1, a document display processor 10 described in the first exemplary embodiment is configured by a computer that displays an image acquired by visualizing electronic data (hereinafter called a visualized image) and is roughly provided with an information storage 11 that stores information if necessary, an image display 12 such as a display, an information input section 13 configured by an input unit such as a keyboard and a mouse and an information processor 14 realized by the combination of a central processing unit (CPU), a random access memory (RAM) and others. The document display processor 10 may also be connected to another device (not shown) via a network to realize various functions by communication with another device.

In the information storage 11, electronic data 11a to be displayed is stored. The electronic data 11a is that of a document having a concept of a page (a sheet) as described above and is managed in a state in which an individual data file name is added to each electronic data. Further, the electronic data may also be managed in a state in which the electronic data is stored in a folder to which an individual folder name is added. The information storage 11 stores display position set information 11b described in detail later as one of attribute information of the electronic data 11a or as one of attribute information incident to a folder including the electronic data 11a.

The image display 12 displays a visualized image of the electronic data 11a. However, there is a certain constraint on screen area size in which the visualized image is displayed. Then, on a screen of the image display 12, apart of a visualized image is selectively displayed as an initial condition of display when the display size of the visualized image is larger than the screen area size.

The information processor 14 edits the electronic data 11a and applies processing such as working to the electronic data, and controls the operation of the information storage 11, the image display 12 and the information input section 13 required for the above-mentioned processing. For the control over the operation, particularly for control when the image display 12 displays a visualized image of the electronic data 11a, the information processor 14 is provided with a function as a display controller 14a.

The display controller 14a controls the display of a visualized image by the image display 12. Further detailedly, the display controller selects a part of a visualized image displayed in its initial condition when the image display 12 selectively displays a part of the visualized image as the initial condition of display. The display controller 14a selects the part for electronic data 11a or for a folder based upon display position set information 11b, which are set for electronic data 11a or for a folder including the electronic data.

Each function of these 11 to 14 and 14a is realized when a resource as a computer of the document display processor 10 executes a predetermined program. In that case, the predetermined program may also be provided in a state in which the predetermined program is stored on a computer readable record medium prior to the installation in the document display processor 10 or may also be distributed via a wire or wireless communication section. That is, the document display processor 10 described in this exemplary embodiment can also be realized by the document display processing program which can be installed in the document display processor 10.

Next, an example of processing operation in the document display processor (including a case realized by the document display processing program) 10 configured as described above will be described.

In the document display processor 10 in the first exemplary embodiment, the display position set information 11b related to the electronic data 11a is supposed to be already set prior to displaying a visualized image of the electronic data 11a.

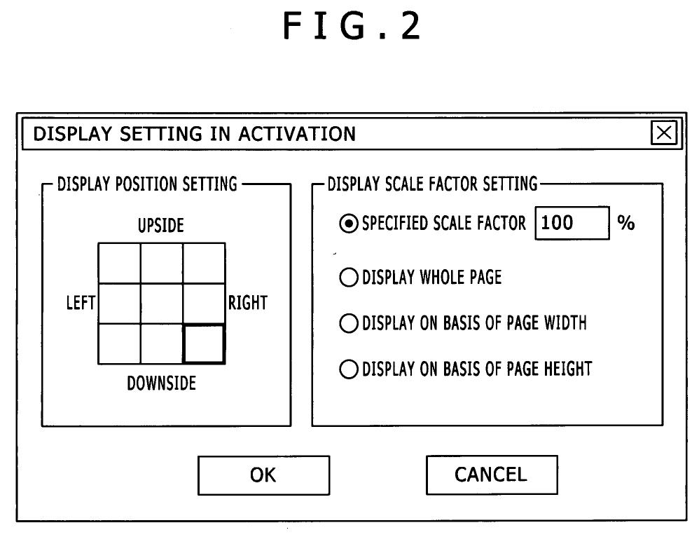

FIG. 2 is an explanatory drawing showing an example of a setting dialog box of display position set information. When the display position set information 11b is set, the image display 12 displays the setting dialog box like the example shown in FIG. 2 on its screen. The setting dialog box has only to be displayed according to a trigger using a predetermined operation on the information input section 13 as the trigger. For example, it is considered that when an operation for requesting the setting of the display position set information 11b is performed by clicking a menu bar and a plug-in button on a display window screen while a visualized image of the electronic data 11a is displayed or while an image representing a folder in which the electronic data 11a is stored is displayed, the setting dialog box is displayed according to this operation. On the setting dialog box, it may be set which part of a visualized image is to be selectively displayed in the initial condition of the display of the electronic data 11a by the image display 12. In the example shown in FIG. 2, any of “left upper area”, “middle upper area”, “right upper area”, “left middle area”, “central area”, “right middle area”, “left lower area”, “middle lower area” or “right lower area” may be selected and specified. Note that the selection of an area is not necessarily limited to the mode in the example. When information is set by a user utilizing the setting dialog box described above, the display position set information 11b which is the result of the setting is stored in the information storage 11 per electronic data 11a or per folder in a state in which the display position set information is related to the corresponding electronic data 11a or the corresponding folder, as one of the attribute information of the electronic data 11a or the folder, for example. As for the display of the setting dialog box, well-known graphical user interface (GUI) technology has only to be used, the detailed description is omitted.

After the display position set information 11b is set as described above, the image display 12 displays the visualized image of the electronic data 11a related to the request when the operation for requesting the display of the visualized image of the electronic data 11a is performed via the information input section 13. At this time, if the display size of the visualized image is larger than screen area size for example, a part of the visualized image is selectively displayed in the initial condition of the display.

In this case, the display position set information 11b is set as a part of the attribute information of the electronic data 11a upon which the visualized image is based or the folder storing the electronic data 11a when a part of the visualized image is selectively displayed by the image display 12. So, the display controller 14a selects and which part of the visualized image is to be displayed in the initial condition per electronic data 11a or per folder based upon the display position set information 11b. That is, as the display position set information 11b is stored as a part of the attribute information of the electronic data 11a or the folder when the display position set information 11b is once set, contents specified in the display position set information 11b have an effect when a part of the visualized image is selectively displayed after that. In addition, the display position set information 11b can be set per electronic data 11a or per folder. This means that a display area in the initial condition may be differently selected per electronic data 11a or per folder.

### Second Embodiment

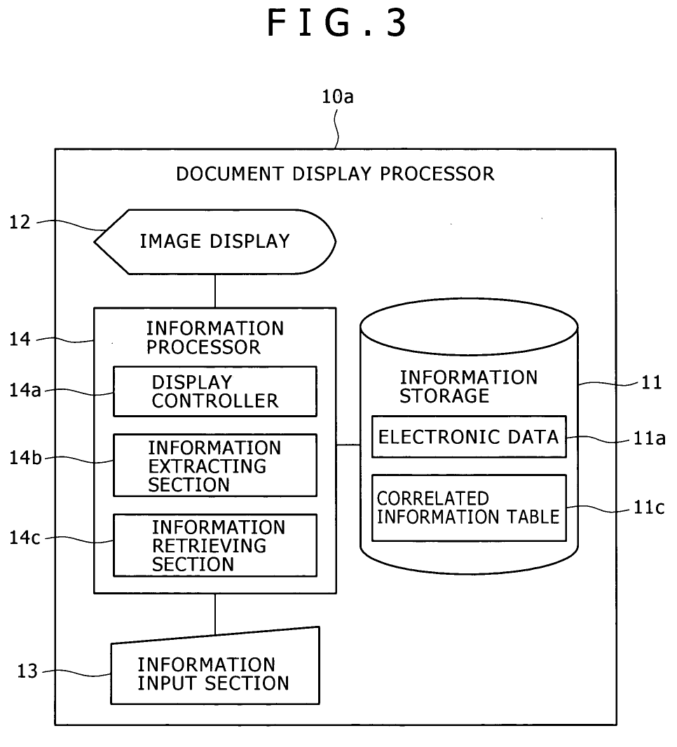

Next, a second exemplary embodiment of the invention will be described only points at which the second exemplary embodiment is different from the first exemplary embodiment will be described below. FIG. 3 is a block diagram showing an example of the second schematic configuration of the document display processor according to the invention.

As shown in FIG. 3, a document display processor 10a described in the second exemplary embodiment is different from the document display processor in the first exemplary embodiment in that an information storage 11 stores a correlated information table 11c and an information processor 14 is provided with functions as an information extracting section 14b and an information retrieving section 14c.

The correlated information table 11c stores information on the configuration of electronic data 11a and information on an initial display position that fits the configuration in a state in which both are correlated.

The attribute information of electronic data 11a may be mainly specified by information on the configuration of the electronic data 11a, and for example, it may include a file name of the electronic data 11a, a language type and a font type used in the electronic data 11a, the distinction of a vertical line or a horizontal line, paper size, an object type existing in the electronic data 11a and information for specifying application software and others used for generating the electronic data 11a. For information on the configuration of electronic data 11a, at least one type of these may be used.

In the meantime, the information of the initial display position means information for specifying which part of a visualized image is to be displayed when a part of the visualized image is selectively displayed in an initial condition of the display of electronic data 11a. For example, it may include information such as “left upper area”, “middle upper area” . . . . As the information of the initial display position fits the configuration of the electronic data 11a, information considered as adequate is correlated per content of the information on the configuration of the electronic data 11a.

The information extracting section 14b extracts information on the configuration of electronic data 11a to be displayed by the image display 12. For extracting the information, the attribute information of the electronic data 11a has only to be used.

The information retrieving section 14c retrieves and extracts the information of an initial display position corresponding to the result of the extraction by the information extracting section 14b from the correlated information table 11c and sends the extracted information of the initial display position to the display controller 14a.

In the second exemplary embodiment described above, the functions as each section 14b, 14c are also realized when a resource as a computer of the document display processor 10a executes a predetermined program. In that case, the predetermined program may also be stored and provided in a computer readable record medium prior to the installation in the document display processor 10a or may also be distributed via a wire or wireless communication section. That is, the document display processor 10a described in this exemplary embodiment can also be realized by a document display processing program which can be installed in the document display processor 10a.

Next, an example of processing operation in the document display processor (including a case realized by the document display processing program) 10a having the above-mentioned configuration will be described.

In the document display processor 10a in the second exemplary embodiment, prior to the display of a visualized image of electronic data 11a, the correlated information table 11c is supposed to be already registered in the information storage 11.

Afterward, when an operation for requesting the display of the visualized image of the electronic data 11a is performed via the information input section 13, the image display 12 displays the visualized image of the electronic data 11a related to the request. When the display size of the visualized image is larger than screen area size, a part of the visualized image is selectively displayed in an initial condition of display.

At this time, the information extracting section 14b extracts information on the configuration of the electronic data 11a to be displayed. The information retrieving section 14c retrieves and extracts the information of an initial display position corresponding to the result of the extraction by the information extracting section 14b from the correlated information table 11c and sends the information to the display controller 14a. Therefore, when the image display 12 selectively displays a part of the visualized image, the display controller 14a selects which part of the visualized image is to be displayed in the initial condition per electronic data 11a based upon the information of the initial display position sent from the information retrieving section 14c.

As a concrete example, the following example can be given. For example, since the possibility that electronic data 11a is that of a drawing is high when letters “drawing” are included in a file name of the electronic data 11a to be displayed, a right lower area of paper in which a title is arranged is specified as an initial display position. Since a sentence is written from a right upper area to a left lower area on paper when a language type of electronic data 11a to be displayed is “Arabic” when a font type of electronic data 11a is “font on vertical line” or when electronic data 11a corresponds to a format of a vertical line, the right upper area is specified as an initial display position. As the possibility that electronic data 11a is that of a drawing is high when “A0 size” is specified as the paper size of the electronic data 11a to be displayed, a right lower area on paper in which a title is arranged is specified as an initial display position. Besides, for example, priority is set per object type in electronic data 11a to be displayed beforehand and not a graphic object the significance of which is low but a text object the significance of which is high is specified so that the text object is in an initial display position according to the priority.

As described above, since information on the configuration of electronic data 11a and the information of an initial display position that fits the configuration are stored in a state in which both are correlated in the correlated information table 11c, contents specified per electronic data 11a to be displayed in the correlated information table 11c have an effect when a part of a visualized image is selectively displayed. This means that the selection of a display area in an initial condition may be different per electronic data 11a.

### Third Embodiment

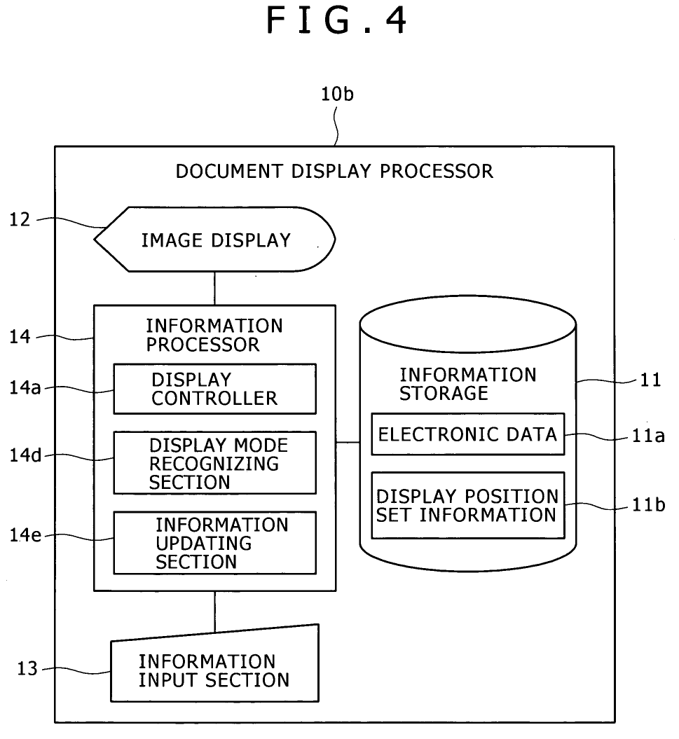

Next, a third exemplary embodiment of the invention will be described. In this case, only points in which the third exemplary embodiment is different from the first exemplary embodiment will also be described below. FIG. 4 is a block diagram showing an example of third schematic configuration of the document display processor according to the invention.

As shown in FIG. 4, a document display processor 10b described in the third exemplary embodiment is different from that in the first exemplary embodiment in that an information processor 14 is provided with functions as a display mode recognizing section 14d and an information updating section 14e.

The display mode recognizing section 14d recognizes a change of a display mode of a visualized image on a screen of an image display 12 from after the visualized image is displayed in an initial condition by the image display 12 until predetermined processing is applied to electronic data 11a upon which the visualized image is based. For the predetermined processing applied to the electronic data 11a, an operation first executed for editing or working the electronic data 11a after the visualized image of the electronic data 11a is displayed can be given. However, the invention is not limited to this and the predetermined processing has only to be set beforehand. For a change of the display mode on the screen of the image display 12, a change by scrolling and by an operation on another user interface by a user can be given. As well-known technique has only to be utilized for a method of recognizing a change of a mode, its detailed description is omitted.

The information updating section 14e updates information to be a basis when a display controller 14a makes the selection of the display of a visualized image according to the result of the recognition by the display mode recognizing section 14d, that is, the contents of display position set information 11b stored in an information storage 11. That is, the information updating section 14e updates the contents of the display position set information 11b by a so-called learning function. The learning function may be realized utilizing well-known technique. Therefore, the information updating section 14e may not immediately update the contents of the display position set information 11b based upon the result of the recognition by the display mode recognizing section 14d. It may also update the contents according to the statistical result of an event occurrence frequency, that is, may also suitably regulate learning intensity.

In the third exemplary embodiment described above, the functions as each section 14d, 14e are also realized when a resource as a computer of the document display processor 10b executes a predetermined program. In that case, the predetermined program may also be provided in a state in which the predetermined program is stored on a computer readable record medium prior to the installation in the document display processor 10b or may also be distributed via a wire or wireless communication section. That is, the document display processor 10b described in this exemplary embodiment can also be realized by a document display processing program which can be installed in the document display processor 10b.

According to the document display processor 10b having the above-mentioned configuration (including a case realized by the document display processing program), since a change of a display mode after display in an initial condition is recognized and the contents of the display position set information 11b to be a basis when the display controller 14a makes the selection of the initial condition are updated according to the result of the recognition, it can be realized that, when scrolling tends to be made after the display in the initial condition, then scrolling is recognized, and setting is changed so that a display mode after the scrolling is an initial condition. That is, a change of the display mode after the display in the initial condition is learned and the learning can help the selection of an initial condition of display after that. At this time, the contents of the display position set information 11b are updated in a state in which the result of the recognition by the display mode recognizing section 14d and each piece of electronic data 11a upon which the recognition is based are correlated. Concretely, if a user scrolls at certain probability or more when a visualized image of electronic data 11a is displayed in an initial condition, the contents of the display position set information 11b corresponding to the electronic data 11a are updated so that a display mode after the scrolling is an initial condition.

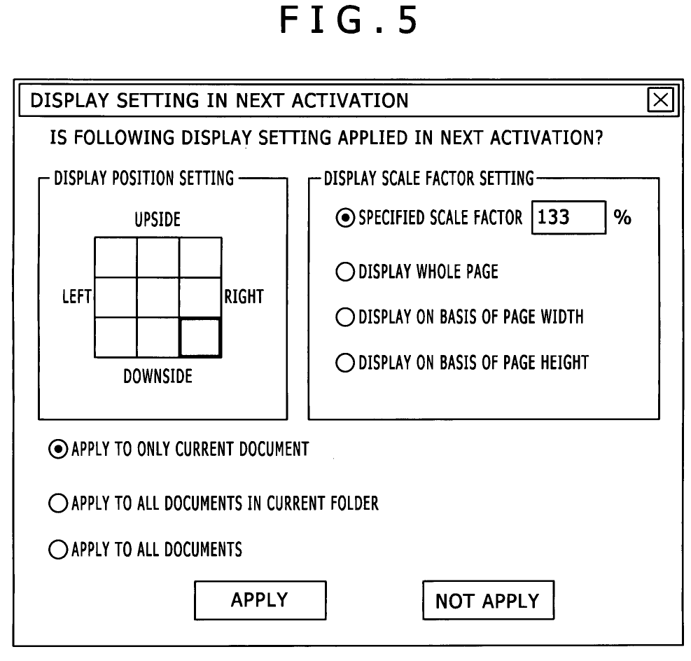

When information is updated by the information updating section 14e, it is also conceivable that a user is inquired to avoid excessive learning. FIG. 5 is an explanatory drawing showing one concrete example of a dialog box for changing the setting of display position set information. When the contents of the display position set information 11b are updated, the image display 12 displays a setting change dialog box shown in FIG. 5 on its screen. The setting change dialog box has only to be displayed using a predetermined operation on an information input section 13 as a trigger. For example, it is conceivable that when predetermined processing applied to electronic data 11a which the display mode recognizing section 14d uses as a trigger for finishing recognition and an operation for finishing processing such as editing and working electronic data 11a is performed, the setting change dialog box is displayed according to it. On the setting change dialog box, a user can be asked to verify the result of the recognition by the display mode recognizing section 14d, that is, updated setting (area specification) contents. The example in FIG. 5 shows a case that it is displayed which of “left upper area”, “middle upper area”, “right upper area”, “left middle area”, “central area”, “right middle area”, “left lower area”, “middle lower area” and “right lower area” is the result of the recognition so as to request a user to verify. However, it need scarcely be said that the setting change dialog box is not necessarily limited to the example. When the user verifies the result of the recognition (the user inputs information of whether the result of the recognition is to be applied or not) utilizing such a setting change dialog box, the result of the recognition has an effect upon the display position set information 11b in the information storage 11. As well-known GUI technology has only to be used for the display of the setting change dialog box, the detailed description is omitted.

Therefore, serviceability for a user is more enhanced because a change of the display mode after the display in the initial condition automatically has an effect upon the selection of the display of a visualized image in an initial condition when the document display processor 10b described in the third exemplary embodiment is used.

The concrete examples of the embodiments of the invention have been described; however, the invention is not limited to the contents. For example, in the third exemplary embodiment, the case that the contents of the display position set information 11b are updated by the learning function is described. It is also conceivable, however, that this is combined with the contents described in the second exemplary embodiment and information stored in the correlated information table 11c is updated. As described above, the invention is not limited to the contents of the first to third exemplary embodiments and the contents of the first to third exemplary embodiments can be suitably changed in a range which does not deviate from the purport of the invention.

What is claimed is:

1. A document display processor, comprising:
an image display that displays an image of electronic data and selectively displays a part of the image as an initial condition of the display; and
a display controller that selects which part of the image is to be displayed as the initial condition by the image display, the selection is performed per electronic data or per folder storing the electronic data.

2. The document display processor according to claim 1, wherein the display controller makes the selection based upon display position set information which is set per electronic data or per folder.

3. The document display processor according to claim 1, comprising:
a correlated information table that stores information on configuration of the electronic data and information of an initial display position that corresponds to the configuration;
an information extracting section that extracts the information on the configuration of the electronic data from the electronic data to be displayed; and
an information retrieving section that retrieves the information of the initial display position corresponding to the extracted information on the configuration,
wherein the display controller makes the selection based upon the retrieved information of the initial display position.

4. The document display processor according to claim 1, further comprising:
a display mode recognizing section that recognizes a change of a display mode on a screen of the image display between a time when a visualized image is displayed in the initial condition and a time when predetermined processing is performed to the electronic data; and
an information updating section that updates information to be a basis when the display controller makes the selection according to a result of the recognition by the display mode recognizing section.

5. The document display processor according to claim 2, further comprising:
a display mode recognizing section that recognizes a change of a display mode on a screen of the image display between a time when a visualized image is displayed in the initial condition and a time when predetermined processing is performed to the electronic data; and
an information updating section that updates information to be a basis when the display controller makes the selection according to a result of the recognition by the display mode recognizing section.

6. The document display processor according to claim 3, further comprising:
a display mode recognizing section that recognizes a change of a display mode on a screen of the image display between a time when a visualized image is displayed in the initial condition and a time when predetermined processing is performed to the electronic data; and
an information updating section that updates information to be a basis when the display controller makes the selection according to a result of the recognition by the display mode recognizing section.

7. The document display processor according to claim 1, wherein
the display controller further selects a display magnification of the image data in the initial condition.

8. A computer readable medium storing a program causing a computer to execute a process for display processing, the process comprising:
displaying an image of electronic data and selectively displaying a part of the image as an initial condition of the display; and
selecting which part of the image is to be displayed as the initial condition, the selection is performed per electronic data or per folder storing the electronic data.

9. A computer data signal embodied in a carrier wave for enabling a computer to perform a process for display processing, the process comprising:
displaying an image of electronic data and selectively displaying a part of the image as an initial condition of the display; and
selecting which part of the image is to be displayed as the initial condition, the selection is performed per electronic data or per folder storing the electronic data.

10. A document display processing method comprising:
displaying an image of electronic data and selectively displaying a part of the image as an initial condition of the display; and
selecting which part of the image is to be displayed as the initial condition, the selection is performed per electronic data or per folder storing the electronic data.
